(19) United States
(12) Patent Application Publication
(10) Pub. No.: US 2011/0007246 A1
(43) Pub. Date: Jan. 13, 2011

(54) LIQUID CRYSTAL DISPLAY DEVICE

(76) Inventor: Jong-Won MOON, Gyeonggi-do (KR)

Correspondence Address: MORGAN LEWIS & BOCKIUS LLP, 1111 PENNSYLVANIA AVENUE NW, WASHINGTON, DC, 20004, US

(21) Appl. No.: 12/832,172

(22) Filed: Jul. 8, 2010

(30) Foreign Application Priority Data
Jul. 13, 2009 (KR) 10-2009-063748

(51) Int. Cl. G02F 1/1335

(52) U.S. Cl. 349/96; 349/117

(57) ABSTRACT

An LCD device is disclosed. The LCD device includes: a liquid crystal display panel; a backlight unit, under the liquid crystal display panel, configured to apply light to the liquid crystal display panel; a compensation film disposed on the liquid crystal display panel; and a fixing member disposed over the compensation film and configured to fix the liquid crystal display panel, the backlight unit, and the compensation film. The compensation film is configured to include a retardation film and a cholesteric liquid crystal polarizing film and to reflect wavelength band light suitable for a color tone of the fixing member, so that a color tone for a standby screen state of the liquid crystal display panel is determined.

### CROSS-REFERENCE TO RELATED APPLICATION

This application claims priority under 35 U.S.C. 119 to Korean Patent Application No. 10-2009-0063748, filed on 13 Jul., 2009, which is hereby incorporated by reference in its entirety.

### BACKGROUND

1. Field of the Disclosure

This disclosure relates to a liquid crystal display (LCD) device.

2. Description of the Related Art

With the recently rapid development of an information-communication field, display devices used in displaying a variety of information have been highlighted more and more. However, cathode ray tubes (CRTs), as one of existing display devices, can not meet the recent requirements of customers, such as a light weight and a small size, because of their major hindrance.

To address this matter, flat display devices including LCD devices, plasma display panels (PDPs), electro luminescence display (ELD) devices, and so on have been developed to meet the requirements of customers. These flat display devices are actively being researched and developed up to the present.

Among the flat display devices, the LCD devices have advantages such as lightness, thinness, and low power consumption driving. As such, the LCD devices are being used as display devices not only for mobile terminals and notebook computers but also for desk top computers and enlarged televisions. In other words, the LCD devices have been widely used in a variety of fields. Furthermore, a demand for the LCD device steadily increases.

The LCD device is based on a driving principle employing an optical isotropic property and a polarization phenomenon of the liquid crystal. The liquid crystal molecules can be directionally aligned due to their thin and long shapes. Also, a direction of the molecular alignment can be controlled by artificially applying an electric field to the liquid crystal. These characteristics of the liquid crystal correspond to major factors causing the polarity variation of light which passes through the liquid crystal.

Such an LCD device includes an LCD panel, a backlight unit disposed under the LCD panel, and a case disposed on an upper portion of the LCD panel. The backlight unit is configured to apply light to the LCD panel. The upper surface edge and lower surface of the LCD panel are fixed by the case.

The case is configured to have an opening allowing an image on the LCD panel to be visible to users. In other words, the case is formed to have a window plate protecting the LCD panel and allowing information displayed on the LCD panel to be visible to users through the opening. Also, the LCD panel displaying the image that is visible to the users through the opening and the backlight unit under the LCD panel are received into the case.

Meanwhile, the LCD device is in a standby screen state when images are not displayed. The standby screen state can be displayed in a variety of colors according to requirements of customers. Actually, the standby screen state is displayed in a normally black mode, a normally white mode, or a color mode of the protective layer which is formed on the most upper layer of the LCD panel.

However, the case can be formed in a randomly selected color. As such, the color of the standby screen state can be different from the color of the case. In this case, the LCD device provides an inharmonious (or an unfamiliar) color tone to user. Therefore, the user of the LCD device may have an awkward impression (or an unfamiliar impression).

### BRIEF SUMMARY

Accordingly, the present embodiments are directed to an LCD device that substantially obviates one or more of problems due to the limitations and disadvantages of the related art.

An object of the present embodiment is to provide an LCD device that allows a standby screen state to be displayed in a color which is determined according to the color of its case.

Additional features and advantages of the embodiments will be set forth in the description which follows, and in part will be apparent from the description, or may be learned by practice of the embodiments. The advantages of the embodiments will be realized and attained by the structure particularly pointed out in the written description and claims hereof as well as the appended drawings.

According to one general aspect of the present embodiment, an LCD device includes: a liquid crystal display panel; a backlight unit, under the liquid crystal display panel, configured to apply light to the liquid crystal display panel; a compensation film disposed on the liquid crystal display panel; and a fixing member disposed over the compensation film and configured to fix the liquid crystal display panel, the backlight unit, and the compensation film. The compensation film is configured to include a retardation film and a cholesteric liquid crystal polarizing film and to reflect wavelength band light suitable for a color tone of the fixing member, so that a color tone for a standby screen state of the liquid crystal display panel is determined.

The retardation film can be configured to have a λ/4 phase retardation characteristic and to include at least one of a quarter wave plate with a forward scattering property, a quarter wave plate with a backward scattering property, and a half wave plate.

The cholesteric liquid crystal polarizing film can be configured to include liquid crystal molecules which are aligned to form a helical structure with a pitch along an axis.

The compensation film can be configured to include a pressure sensitive adhesive layer, a quarter wave plate with one of forward and backward scattering properties, and the cholesteric liquid crystal polarizing film sequentially stacked.

The compensation film can be further configured to include another pressure sensitive adhesive layer and a transparent isotropic substrate between the quarter wave plate with one of the forward and backward scattering properties and the cholesteric liquid crystal polarizing film.

The compensation film can be still further configured to include another pressure sensitive adhesive layer between the quarter wave plate with one of the forward and backward scattering properties and the cholesteric liquid crystal polarizing film, and a transparent isotropic substrate on the cholesteric liquid crystal polarizing film.

The compensation film is configured to include a first pressure sensitive adhesive layer, a half wave plate with a forward scattering property, a second pressure sensitive adhesive layer, a quarter wave plate with the forward scattering property, and the cholesteric liquid crystal polarizing film sequentially stacked.

The compensation film is further configured to include a third pressure sensitive adhesive layer and a transparent isotropic substrate between the quarter wave plate with the forward scattering property and the cholesteric liquid crystal polarizing film.

The compensation film can be still further configured to include a third pressure sensitive adhesive layer between the quarter wave plate with the forward scattering property and the cholesteric liquid crystal polarizing film, and a transparent isotropic substrate on the cholesteric liquid crystal polarizing film.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the embodiments and are incorporated in and constitute a part of this application, illustrate embodiment(s) of the invention and together with the description serve to explain the disclosure. In the drawings:

FIG. 1 is an explored perspective view schematically showing an LCD device according to an LCD device of the present disclosure;

FIG. 2 is a cross-sectional view schematically showing an LCD panel according to an embodiment of the present disclosure;

FIG. 3A through 3I are cross-sectional views showing compensation films according to first through ninth embodiments of the present disclosure; and

FIG. 4 is a cross-sectional view, which is used to explain a characteristic variation of light in a standby mode, showing the LCD device with the compensation film according to a first embodiment of the present disclosure.

### DETAILED DESCRIPTION

Reference will now be made in detail to the embodiments of the present disclosure, examples of which are illustrated in the accompanying drawings. These embodiments introduced hereinafter are provided as examples in order to convey their spirits to the ordinary skilled person in the art. Therefore, these embodiments might be embodied in a different shape, so are not limited to these embodiments described here. Also, the size and thickness of the device might be expressed to be exaggerated for the sake of convenience in the drawings. Wherever possible, the same reference numbers will be used throughout this disclosure including the drawings to refer to the same or like parts. Furthermore, it will be understood that when an element, such as a substrate, a layer, a region, a film, or an electrode, is referred to as being formed “on” or “under” another element in the embodiments, it may be directly on or under the other element, or intervening elements (indirectly) may be present. The term “on” or “under” of an element will be determined based on the drawings. In the drawings, the sides of elements can be exaggerated for clarity, but they do not mean the practical sizes of elements.

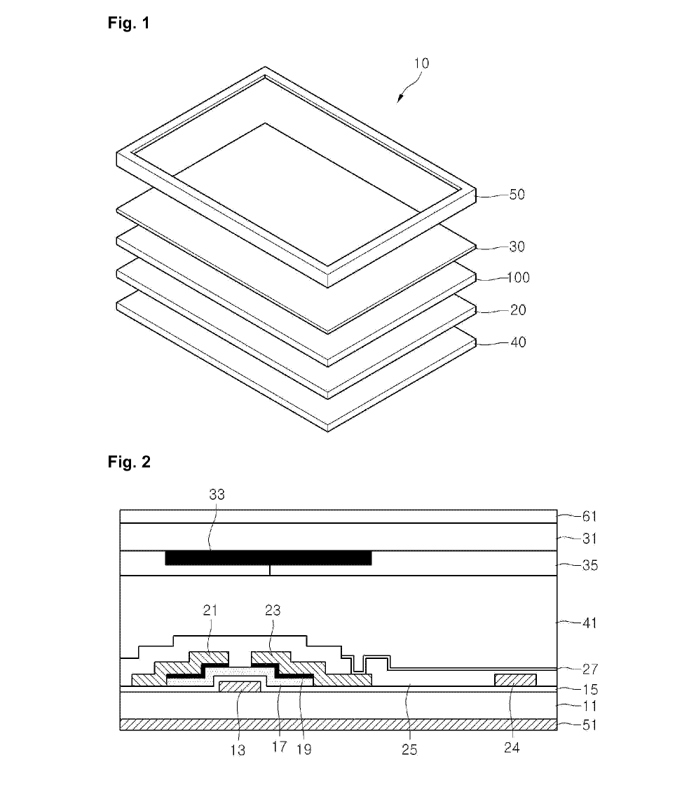

FIG. 1 is an explored perspective view schematically showing an LCD device according to an LCD device of the present disclosure;

As shown in FIG. 1, the LCD device 10 includes an LCD panel 100, a backlight unit 20 disposed under the LCD panel 100, and a compensation film (or sheet) 30 disposed on an upper portion of the LCD panel 100. The backlight unit 20 is configured to apply light to the LCD panel 100. The compensation film 30 is configured to include a retardation film (or sheet) and a CLC (Cholesteric Liquid Crystal) polarizing film (or sheet).

The LCD device 10 according to the first embodiment of the present disclosure further includes a support member 40 and a fixing member 50 which are used to support and fix the LCD panel 100, the backlight unit 20, and so on. The support member 40 is disposed under the backlight unit 20 so as to perform a function of supporting the backlight unit 20 and the LCD panel 100. The fixing member 50 is disposed on an upper portion of the compensation film 30 and is engaged with the support member 40, so as to perform functions of fixing and protecting the LCD device 100, the compensation film 30, and the backlight unit 20. Such a support member can be configured to include at least one of a support main (not shown), a bottom cover (not shown), and so on. On the other hand, the fixing member 50 can be configured to include a case and so on. The case can be formed in a variety of colors corresponding to requirements of users.

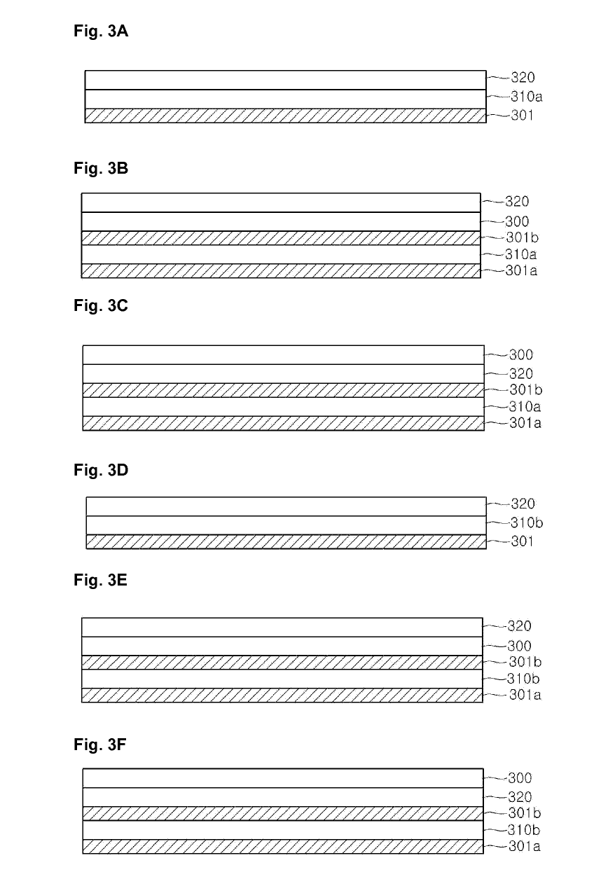

The LCD panel 100 is configured to include a lower array substrate (or a thin film transistor substrate) and an upper array substrate (or a color filter substrate) opposite to each other, as shown in FIG. 2. The lower and upper array substrates are separate from and each other at a fixed distance. A liquid crystal layer 41 is interposed between the two array substrates.

The lower array substrate is configured to include gate and data lines (not shown) which are formed in a matrix shape on the inner surface of a first transparent substrate 11. Also, the lower array substrate is configured to include thin film transistors, pixel electrodes 27, common electrodes 24, and a lower alignment film (not shown). Each of the thin film transistors is used to function as a switching element. Each of the thin film transistors is formed at an intersection of the gate and data lines. The pixel electrodes 27 contacting the drain electrodes 23 of the respective thin film transistors are formed within regions which are defined by the gate and data lines, respectively. Each of the common electrodes 24 is formed in such a manner as to be separated from the respective drain electrode 23 by a fixed distance. The lower alignment film is formed on the pixel electrodes 27. The reference numbers 13, 15, 17, 19, 21, and 25 in FIG. 2 indicate a gate electrode of the thin film transistor, a gate insulation film, an active layer, an ohmic contact layer, a source electrode of the thin film transistor, and a protective (passivation) layer, respectively.

On the other hand, the upper array substrate is configured to include a black matrix 33 and a color filter layer 35 which are formed on an inner surface of a second transparent substrate 31 opposite to the first transparent substrate 11 with the plurality of pixel electrodes 27. The upper array substrate is further configured to include an upper alignment film (not shown) formed on the color filter layer 35.

The LCD panel 100 is further configured to include first and second polarizing plates 51 and 61 which are disposed on outer surfaces of the first and second transparent substrates 11 and 31. A light axis of the first polarizing plate 51 is perpendicular to that of the second polarizing plate 61. For example, the light axis of the first polarizing plate 51 becomes an angle of 90° when the light axis of the second polarizing plate 61 is set to an angle of 0°.

When voltages are selectively applied to one gate line and one data line on the above configured LCD panel, thin film transistors receiving the voltages are turned-on (or activated). Then, electric charges are charged into the pixel electrodes 27 connected to the respective drain electrodes 23 of the turned-on thin film transistors, so that horizontal electric fields are generated between the pixel electrodes 27 and the common electrodes 24. The horizontal electric field changes the liquid crystal molecular alignment.

The compensation film 30 determines a color tone for the standby screen state of the LCD panel 100. To this end, the compensation film 30 reflects wavelength band lights suitable for (or in harmony with) the color tone of a case which is used as the fixing member 50. Also, the compensation film 30 disposed on the upper portion of the LCD panel 100 can be configured to include the retardation film, the CLC polarizing film, and so on.

The retardation film is used to apply circularly polarized light to the CLC polarizing film. To this end, the retardation film converts linearly polarized light into the circularly polarized light or inversely converts the circularly polarized light into the linearly polarized light. As such, the retardation film is formed to have a λ/4 phase retardation characteristic. As an example, at least one of a quarter-wave plate with a forward scattering property, a quarter-wave plate with a backward scattering property, and a half-wave plate can be used to form the retardation film.

The CLC polarizing film is formed by hardening cholesteric liquid crystal in a plate. The cholesteric liquid crystal molecules included in the CLC polarizing film are aligned in a helical structure along an axis. As such, the helical CLC alignment has a pitch “p” corresponding to its one cycle (or one rotation period).

Such a CLC polarizing film reflects a circularly polarized light having the same rotation direction as that of the helical CLC-molecular alignment (or that of the CLC molecule). On the contrary, the CLC polarizing film transmits the other circularly polarized lights having different rotation direction from that of the helical CLC-molecular alignment.

In addition, the CLC polarizing film can selectively reflect light of a specific wavelength band by controlling the pitch of the helical CLC-molecular alignment. In other words, a reflexible wavelength band of the CLC polarizing film depends upon the pitch of the helical CLC-molecular alignment. As such, the reflexible wavelength band of the CLC polarizing film can be selectively determined by controlling the pitch of the helical CLC-molecular alignment.

On the other hand, light being visible to human eyes is limited to a wavelength range of about 400 nm˜700 nm. The lights within this wavelength range are called the “visible lights”. More specifically, red light among the visible lights has a wavelength band near 660 nm, green light has another wavelength band near 530 nm, and blue light has still another wavelength band near 470 nm.

Therefore, the pitch of the helical CLC-molecular alignment can be artificially manipulated (i.e., enlarged or reduced) in order to selectively reflect only specific wavelength band light with a primary color among the visible lights. As a result, a color tone for the standby screen state of the LCD panel 100 can be selectively determined according to the case color of the LCD device 10.

For example, the case of the LCD device 10 can be formed to have a red color. In this case, the standby screen state of the LCD panel 100 can be displayed in the red color by adjusting the pitch of the helical CLC-molecular alignment in the CLC polarizing plate.

When a desired wavelength band light is selected, a method of calculating the pitch of the helical CLC-molecular alignment will be now described.

The wavelength λ of reflexible light can be calculated by the following equation 1:

λ=n×p [symbol] p=λ/n [Equation 1]

wherein “n” is a mean refractive index of the CLC polarizing film, and “p” is the pitch of the helical CLC-molecular alignment. The mean refractive index of the CLC polarizing film can be assumed to be set to a value of 1.5.

Therefore, the pitch “p” of the helical CLC-molecular alignment can be obtained using the equation 1 when a wavelength λ of reflexible (or desired) light is given.

If the reflection of wavelength band light corresponding to a blue color is desired, the pitch “p” can be obtained from the following equation 2.

p=470 nm/1.5=313 nm [Equation 2]

The pitch “p” of the helical CLC-molecular alignment is adjusted to have a length of 313 nm so that the CLC polarizing film reflects only wavelength band light corresponding to the blue color. Accordingly, the standby screen state of the LCD panel 100 can be displayed in the blue color.

Alternatively, when the reflection of wavelength band light corresponding to a green color is desired, the pitch “p” of the helical CLC-molecular alignment can be calculated as the following equation 3.

p=530 nm/1.5=353 nm [Equation 3]

The pitch “p” of the CLC-molecular alignment is adjusted to be set to 353 nm so that the CLC polarizing film reflects only wavelength band light corresponding to the green color. Accordingly, the standby screen state of the LCD panel 100 can be displayed in the green color.

In another manner, if the reflection of wavelength band light corresponding to a red color is desired, the pitch “p” of the helical CLC-molecular alignment can be obtained from the following equation 4.

p=660 nm/1.5=440 nm [Equation 4]

The pitch “p” of the helical CLC-molecular alignment is adjusted to be set to 440 nm so that the CLC polarizing film reflects only wavelength band light corresponding to the red color. Accordingly, the standby screen state of the LCD panel 100 can be displayed in the red color.

As described above, the pitch “p” of the helical CLC-molecular alignment can be adjusted according to the desired wavelength band light on the basis of the equation 1. Therefore, the CLC polarizing film can reflect only the specially desired wavelength band light.

In such a compensation film, a variety of embodiments can be implemented according to configurations of the retardation film and CLC polarizing film.

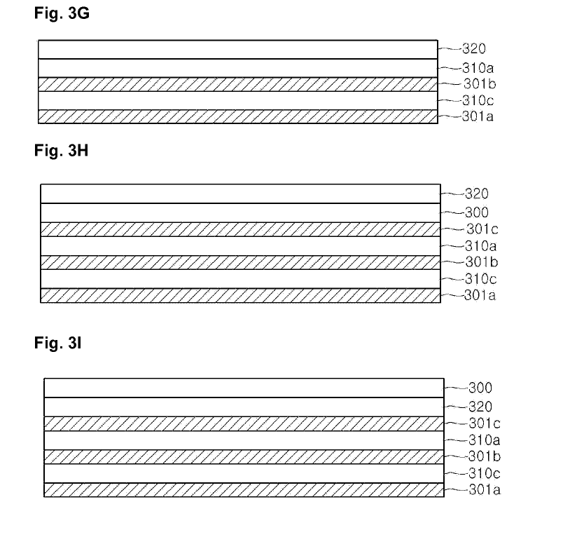

As shown in FIG. 3A, the compensation film 30 according to a first embodiment is configured to include an adhesive layer 301, a retardation film 310a, and a CLC polarizing film 320 sequentially stacked. The adhesive layer 301 is formed from pressure sensitive adhesive (hereinafter, “PSA”). The retardation film 310a is configured to include a quarter wave plate with a forward light-scattering property.

The compensation film 30 according to a second embodiment is configured to include a first adhesive layer 301a, a retardation film 310a, a second adhesive layer 301b, a transparent isotropic substrate 300, and a CLC polarizing film 320 sequentially stacked, as shown in FIG. 3B. The first and second adhesive layers 301a and 301b are formed from PSA. The retardation film 310a is configured to include a quarter wave plate with a forward light-scattering property.

The compensation film 30 according to a third embodiment is configured to include a first adhesive layer 301a, a retardation film 310a, a second adhesive layer 301b, a CLC polarizing film 320, and a transparent isotropic substrate 300 sequentially stacked, as shown in FIG. 3C. The first and second adhesive layers 301a and 301b are formed from PSA. The retardation film 310a is configured to include a quarter wave plate with a forward light-scattering property.

The compensation film 30 according to a fourth embodiment is configured to include an adhesive layer 301, a retardation film 310b, and a CLC polarizing film 320 sequentially stacked, as shown in FIG. 3D. The adhesive layer 301 is formed from PSA. The retardation film 310b is configured to include a quarter wave plate of a backward light-scattering property.

The compensation film 30 according to a fifth embodiment is configured to include a first adhesive layer 301a, a retardation film 310b, a second adhesive layer 301b, a transparent isotropic substrate 300, and a CLC polarizing film 320 sequentially stacked, as shown in FIG. 3E. The first and second adhesive layers 301a and 301b are formed from PSA. The retardation film 310b is configured to include a quarter wave plate with a backward light-scattering property.

The compensation film 30 according to a sixth embodiment is configured to include a first adhesive layer 301a, a retardation film 310b, a second adhesive layer 301b, a CLC polarizing film 320, and a transparent isotropic substrate 300 sequentially stacked, as shown in FIG. 3F. The first and second adhesive layers 301a and 301b are formed from PSA. The retardation film 310b is configured to include a quarter wave plate with a backward light-scattering property.

The compensation film 30 according to a seventh embodiment is configured to include a first adhesive layer 301a, a first retardation film 310c, a second adhesive layer 301b, a second retardation film 310a, and a CLC polarizing film 320 sequentially stacked, as shown in FIG. 3G. The first and second adhesive layers 301a and 301b are formed from PSA. The first retardation film 310c is configured to include a half wave plate with a forward light-scattering property. The second retardation film 310a is configured to include a quarter wave plate with a forward light-scattering property.

The compensation film 30 according to an eighth embodiment is configured to include a first adhesive layer 301a, a first retardation film 310c, a second adhesive layer 301b, a second retardation film 310a, a third adhesive layer 301c, a transparent isotropic substrate 300, and a CLC polarizing film 320 sequentially stacked, as shown in FIG. 3H. The first to third adhesive layers 301a to 301c are formed from PSA. The first retardation film 310c is configured to include a half wave plate with a forward light-scattering property. The second retardation film 310a is configured to include a quarter wave plate with a forward light-scattering property.

The compensation film 30 according to a ninth embodiment is configured to include a first adhesive layer 301a, a first retardation film 310c, a second adhesive layer 301b, a second retardation film 310a, a third adhesive layer 301c, a CLC polarizing film 320, and a transparent isotropic substrate 300 sequentially stacked, as shown in FIG. 3I. The first through third adhesive layers 301a through 301c are formed from PSA. The first retardation film 310c is configured to include a half wave plate with a forward light-scattering property. The second retardation film 310a is configured to include a quarter wave plate with a forward light-scattering property.

Characteristic variations of polarized light through the compensation film 30 of the present embodiment will now be explained in detail in reference with the attached drawing.

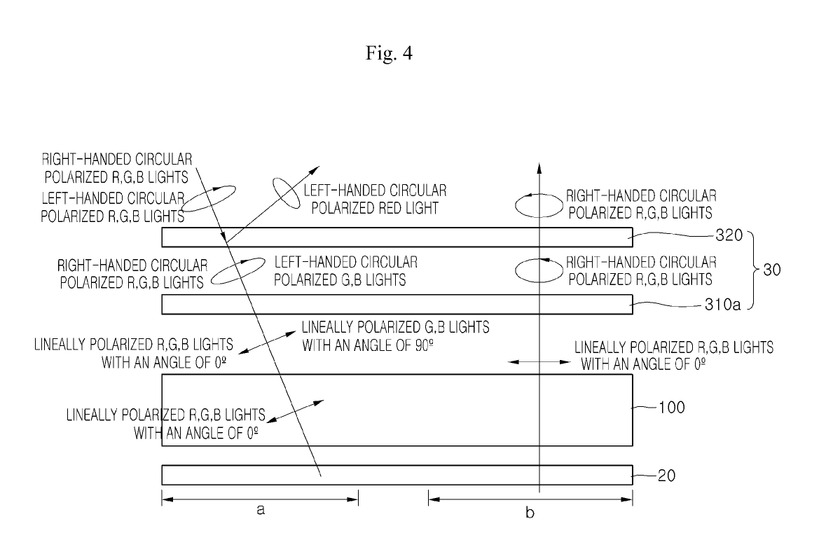

FIG. 4 is a cross-sectional view illustrating a characteristic variation of polarized light when the LCD device with the compensation film according to a first embodiment of the present disclosure is in a standby mode. In FIG. 4, a first region “a” illustrates a characteristic variation of polarized light which progresses in a lateral direction, and a second region “b” illustrates another characteristic variation of polarized light which progresses in a front direction.

The CLC polarizing film 320 included in the compensation film 30 has a helical CLC-molecular alignment of which the pitch is adjusted. As such, the CLC polarizing film 320 selectively reflects only lights within a wavelength band corresponding to the red color. More specifically, the CLC polarizing film 320 reflects only left-handed circular polarized light which is equal to the helical CLC-molecular alignment (or the CLC molecule) in the rotation direction. On the contrary, the CLC polarizing film 320 transmits all the other right-handed circular polarized lights which are different from the rotation direction of the helical CLC-molecular alignment (or the rotation direction of the CLC molecule). The retardation film 310a included in the compensation film 30 is configured to include a quarter wave plate (or a λ/4 plate).

With respect to the characteristic variation of light in the front direction, red, green, and blue lights generated in the backlight unit 20 are output as linearly polarized lights with an angle of 0° through the first and second polarizing films (51 and 61 in FIG. 2) of the LCD panel 100, as shown in the second region “b” of FIG. 4. These linearly polarized red, green, and blue lights change into right-handed circular polarized red, green, and blue lights during passing through the retardation film 310a. The right-handed circular polarized red, green, and blue lights output from the retardation film 310a originally pass through the CLC polarizing film 320 and progress toward users. As such, a display area of the LCD device 10 is transparently visible from the front direction. In other words, any color is not displayed in the front direction.

Subsequently, the characteristic variation of light in the lateral direction will now be described. Referring to the first region “a” of FIG. 4, external light can enter the LCD device 10. The external light includes right-handed circular polarized red, green, and blue lights and left-handed circular polarized red, green, and blue lights. The right-handed circular polarized red, green, and green lights and the left-handed circular polarized green and blue lights originally penetrate through the CLC polarizing film 320 and are output toward the retardation film 310a. On the other hand, the left-handed circular polarized red light is reflected by the CLC polarizing film 320 without entering the retardation film 310a. The right-handed circular polarized red, green, blue lights pass through the retardation film 310a and are output into linearly polarized red, green, and blue lights with an angle of 0°. Similarly, the left-handed circular polarized green and blue lights pass through the retardation film 310a and are output in linearly polarized green and blue lights with an angle of 90°. The linearly polarized red, green, and blue lights with the angle of 0° penetrate through the LCD panel 100, but the linearly polarized green and blue lights with the angle of 90° are absorbed by the second polarizing film 61 corresponding to the most upper layer of the LCD panel 100. Consequently, the display area of the LCD device 10 can be visible in a red color from the lateral direction because of reflecting the left-handed circular polarized red light.

More specifically, the display area of the LCD device 10 according to the present embodiment not only is transparently visible from the front direction but also is tinged with a red tone (or a red color) in the lateral directions, while the LCD device is in a standby mode. As such, the standby screen state of the LCD device 10 can be displayed in a color tone (i.e., the red color) which is proper to or is harmonized with a case color of the LCD device 10. Therefore, the LCD device 10 prevents an extravagant difference or a disharmony between the color tones of the standby screen state and the case. As a result, the LCD device can give a natural feel or a familiar feel to users.

Moreover, the LCD device 10 of the present embodiment can display images without deteriorating the display image quality during a driving mode.

Although the CLC polarizing film 320 is configured to selectively reflect only red wavelength band light as described above, the CLC polarizing film 320 can be configured to selectively reflect green or blue wavelength band light by adjusting the pitch of the helical CLC-molecular alignment. Also, the CLC polarizing film 320 can be formed to reflect the right-handed circular polarized light and to transmit the left-handed circular polarized light, even though the CLC polarizing film 320 is described to reflect the left-handed circular polarized light and to transmit the right-handed circular polarized light.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display device comprising:
a liquid crystal display panel;
a backlight unit, under the liquid crystal display panel, configured to apply light to the liquid crystal display panel;
a compensation film disposed on the liquid crystal display panel; and
a fixing member disposed over the compensation film and configured to fix the liquid crystal display panel, the backlight unit, and the compensation film,
wherein the compensation film is configured to include a retardation film and a cholesteric liquid crystal polarizing film and to reflect wavelength band light suitable for a color tone of the fixing member, so that a color tone for a standby screen state of the liquid crystal display panel is determined.

2. The liquid crystal display device claimed as claim 1, wherein the retardation film is configured to have a λ/4 phase retardation characteristic and to include at least one of a quarter wave plate with a forward scattering property, a quarter wave plate with a backward scattering property, and a half wave plate.

3. The liquid crystal display device claimed as claim 1, wherein the cholesteric liquid crystal film is configured to include liquid crystal molecules which are aligned to form a helical structure with a pitch along an axis.

4. The liquid crystal display device claimed as claim 1, wherein the compensation film is configured to include a pressure sensitive adhesive layer, a quarter wave plate with one of forward and backward scattering properties, and the cholesteric liquid crystal polarizing film sequentially stacked.

5. The liquid crystal display device claimed as claim 4, wherein the compensation film is further configured to include another pressure sensitive adhesive layer and a transparent isotropic substrate between the quarter wave plate with one of the forward and backward scattering properties and the cholesteric liquid crystal polarizing film.

6. The liquid crystal display device claimed as claim 4, wherein the compensation film is further configured to include another pressure sensitive adhesive layer between the quarter wave plate with one of the forward and backward scattering properties and the cholesteric liquid crystal polarizing film, and a transparent isotropic substrate on the cholesteric liquid crystal polarizing film.

7. The liquid crystal display device claimed as claim 1, wherein the compensation film is configured to include a first pressure sensitive adhesive layer, a half wave plate with a forward scattering property, a second pressure sensitive adhesive layer, a quarter wave plate with the forward scattering property, and the cholesteric liquid crystal polarizing film sequentially stacked.

8. The liquid crystal display device claimed as claim 7, wherein the compensation film is further configured to include a third pressure sensitive adhesive layer and a transparent isotropic substrate between the quarter wave plate with the forward scattering property and the cholesteric liquid crystal polarizing film.

9. The liquid crystal display device claimed as claim 7, wherein the compensation film is further configured to include a third pressure sensitive adhesive layer between the quarter wave plate with the forward scattering property and the cholesteric liquid crystal polarizing film, and a transparent isotropic substrate on the cholesteric liquid crystal polarizing film.
